(19) United States
(12) Patent Application Publication
(10) Pub. No.: US 2012/0013483 A1
(43) Pub. Date: Jan. 19, 2012

(54) Water Supply Maintenance System

(76) Inventors: Sungeun Jung, Irvine, CA (US); Yoonrak Hwang, Seoul (KR); Dong Seop Lee, Seoul (KR); Sang Suk Lee, Incheon (KR)

(21) Appl. No.: 12/838,448

(22) Filed: Jul. 17, 2010

(51) Int. Cl. G08B 21/00; G08C 19/16

(52) U.S. Cl. 340/870.16; 340/870.01

(57) ABSTRACT

A GIS-based computerized system is provided for maintaining a water supply system having a pipe network and a plurality of measuring sensors. The maintenance system includes a transmitter that receives information from the measuring sensors, and transmits the information, a collector that collects the information transmitted by the transmitter, an information analyzer that analyzes the collected information and decides prescribed status variables for the maintenance system, a storage that stores information provided by the collector and the information analyzer, an alarm device that generates an alarm when the information analyzer decides a leak expectation, a sensor error or an abnormal operation, a pipe network analyzer that analyzes the pipe network base on the collected information. The pipe network analyzer analyzes the information stored by the storage based on a pipe network scheme that is constructed with space data of the water supply system.

### BACKGROUND OF THE INVENTION

The invention is related to an integrated system for maintaining water supply facilities. More particularly, the invention is related to a computerized water supply maintenance system that is based on GIS, displays real time information collected from flow rate sensors, water pressure sensors, water quality sensors, and decides adequate water pressure and flow rate through pipe network analysis.

Maintenance of a water supply system are related to various factors including flow rate, safe water quality, adequate water pressure, securing emergency supply line, and improvement of facilities, etc. A water supply maintenance system should balance the quantity aspect, that is, expanding water supply and pipe network, and the quality aspect, that is, keeping stability and safety of the pipe network.

A water supply system includes a nation wide pipe network. Number of supply nodes such as taps at home is multiple times of the number of entire population. All the taps are connected to water sources through the pipe network, and the pipe network carries water, a tangible fluid medium that is far more difficult to handle and control than the intangible, wave-form objects of other public networks such as electricity and communication. Also, supply of quality water is directly related to health and safety of the citizens. Factors affecting a water supply system and factors requires to be controlled are many and difficult to handle. An efficient and effective maintenance system for a water supply system, which utilizes and integrates reliable and automatic data collection, data transfer and analysis functions, has long been in need.

### SUMMARY OF THE INVENTION

An object of the invention is to provide a maintenance system that minimizes error and maximizes efficiency in information collection and transfer of information for a water supply system.

Another object of the invention is to provide a maintenance system that effectively integrates all functions for identifying problems of a water supply system and providing solutions.

To achieve the above objects, the present invention provides a maintenance system for a water supply system that includes a pipe network and a plurality of measuring sensors. The maintenance system includes a transmitter that is adapted to receive information from the measuring sensors, and transmits the information, a collector that collects the information transmitted by the transmitter, an information analyzer that analyzes the collected information and decides prescribed status variables for the maintenance system, and a storage that stores information provided by the collector and the information analyzer. Processes of the system for the information and analysis are based on the Geographic Information System (GIS).

The transmitter includes an administration module that administrates processes of the transmitter, an information receiving module that receives information from the measuring sensors, and an information transmission module that transmits the received information. Operations of the administration module, the information receiving module and the information transmission module are independent from one another so that receiving information can be continued in case that the processes fail.

The transmitter receives information from the measuring sensors at a predetermined information reception interval, and converts the received information into effective measuring information at a predetermined transmission interval. The transmitter converts the information according to a first predetermined internal protocol. The first predetermined internal protocol comprises flow rate data, water pressure data, water quality data, alarm data and control data. The flow rate data comprises flow rate measuring state, accumulated flow amount, instantaneous flow amount, and flow speed. The water pressure data comprises instantaneous water pressure. The water quality data comprises water pressure state and measured value, pH value measuring state and measured value, chlorine meter measuring state and measured value, opacity meter measuring state and measured value. The alarm data comprises power failure, control panel door opening and exceeding threshold values. The control data comprises data collection interval change, protocol change, and threshold value change.

The collector converts the information, which are collected from the transmitter, according to a second predetermined internal protocol. The collector organizes the converted information per predetermined time unit. The predetermined time unit includes five (5) minutes, ten (10) minutes, one (1) hour and one (1) day.

The storage stores the collected information, basic information for the pipe network and all information generated by the maintenance system.

The maintenance system further includes an alarm device. The status variables decided by the information analyzer includes a threshold value, a leak expectation, a sensor error, and an abnormal operation. The alarm device generates an alarm when the information analyzer decides a leak expectation, a sensor error or an abnormal operation.

The information collected by the collector includes flow rate, water pressure and water quality. The information analyzer analyzes the water supply system based on the flow rate, water pressure and water quality, and an initial design water pressure value of the pipe network. The information analyzer transfers analyzed result to the alarm device and the storage.

The alarm generated by the alarm device is classified into a plurality of levels. The alarm device delivers the alarm to pre-registered users via public telecommunication network.

The maintenance system further includes a pipe network analyzer that analyzes the pipe network base on the collected information.

The pipe network analyzer includes an analysis storage module, an analysis addition module and an analysis result module. The analysis storage module manages analysis techniques. The analysis addition module enables addition of analysis techniques. The analysis result module provides analysis result.

The pipe network analyzer analyzes the information stored by the storage based on a pipe network scheme that is constructed with space data of the water supply system. Analysis techniques are added as plug-in modules. The analysis storage module chooses an analysis technique. The pipe network analyzer analyzes a metered amount ratio of the water supply system, and calculates water use amount and water supply amount. The information analyzed by the pipe network analyzer includes flow rate, water pressure and water quality.

The operation of the pipe network analyzer comprises creating the pipe network scheme, GIS database structuring, positional data input, height data input, creating water supply model database and performing water supply modeling.

The maintenance system further includes an information transferor that includes an XML output module that outputs information as XML and an XML transfer module that transfer the XML output.

The maintenance system further includes a screen display. The information transferor uses XML for information transfer from the storage to the screen display. The screen display displays the XML output from the information transferor.

The advantageous effects of the present invention are: (1) because the maintenance system is based on GIS standard, manual input, additional conversion and redundant data are avoided, and geometrical and property information are transferred in real time; (2) update is automatically performed for only changed portions; (3) systematic analysis results are provided; (4) the system can be integrated with systems for other underground facilities such as the sewage.

### BRIEF DESCRIPTION OF DRAWINGS

The present invention will become better understood with reference to the accompanying drawings, wherein:

FIG. 1 is a schematic diagram showing a water supply system and a maintenance system for the water supply system according to the present invention;

FIG. 2 is a block diagram showing the maintenance system;

FIG. 3 is a schematic diagram showing water supply pipe properties data for a water supply pipe network;

FIG. 4 is a schematic diagram showing data for flow rate and head loss check process;

FIG. 5 is a schematic diagram showing data flow from a transmitter to a collector, a storage and an information analyzer; and

FIG. 6 is a flow diagram showing pipe network analyzing process.

### DETAILED DESCRIPTION OF THE INVENTION

A water supply system is effectively maintained and improved by constructing a block system that sets blocks on the water supply system, installs sensors and maintains facilities per block, analyzes water use rate or water leak rate, etc. per block, and computerizes maintenance of unit block with telemetry and telecommand.

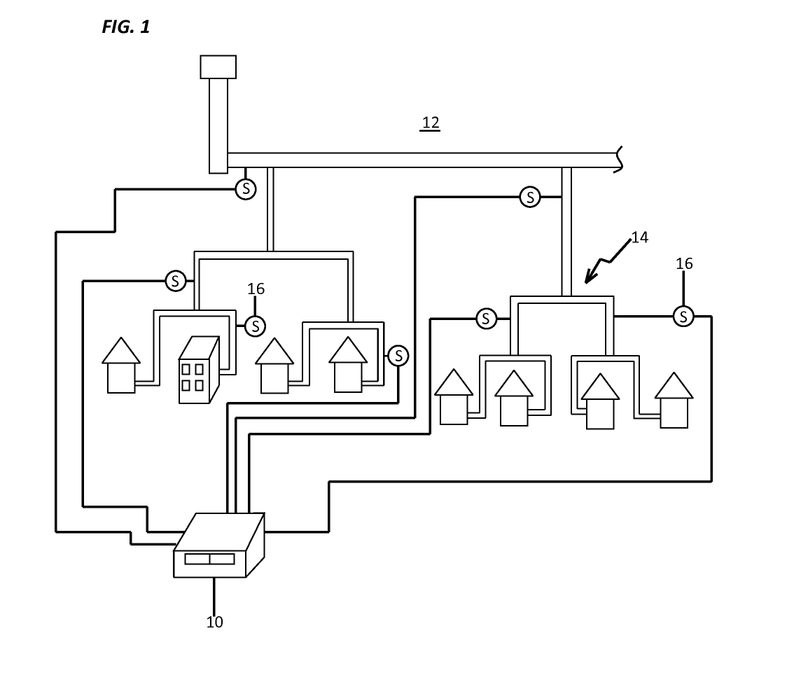

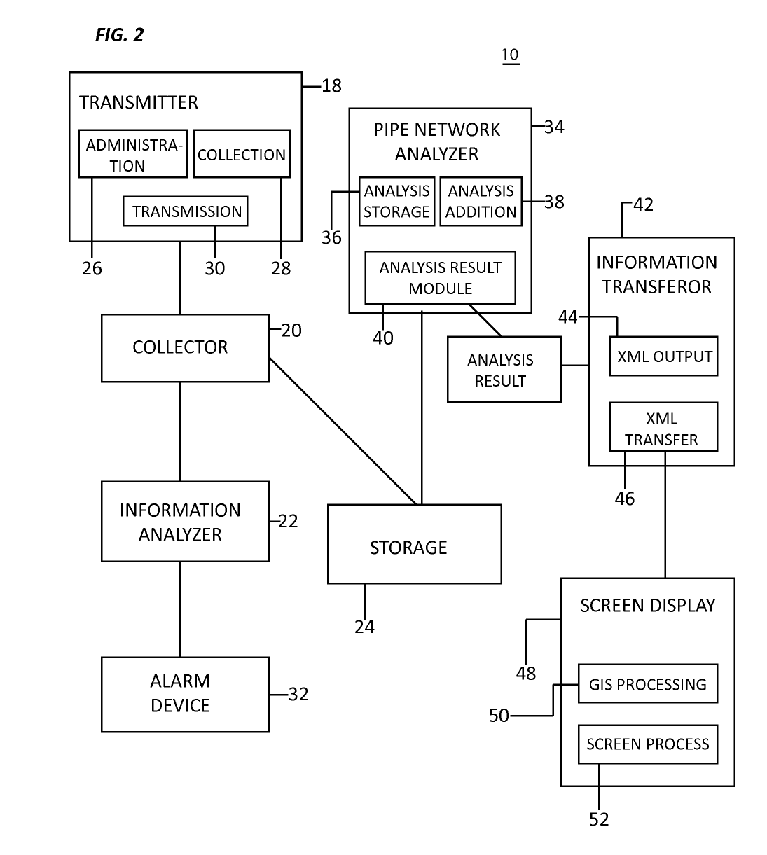

FIG. 1 shows a maintenance system 10 for a water supply system 12 that includes a pipe network 14 and a plurality of measuring sensors 16. FIG. 2 shows that the maintenance system 10 includes a transmitter 18 that is adapted to receive information from the measuring sensors 16, and transmits the information, a collector 20 that collects the information transmitted by the transmitter 18, an information analyzer 22 that analyzes the collected information and decides prescribed status variables for the maintenance system 10, and a storage 24 that stores information provided by the collector 20 and the information analyzer 22. Processes of the maintenance system 10 for the information and analysis are based on GIS.

The transmitter 18 includes an administration module 26 that administrates processes of the transmitter, an information receiving module 28 that receives information from the measuring sensors 16, and an information transmission module 30 that transmits the received information. Operations of the administration module 26, the information receiving module 28 and the information transmission module 30 are independent from one another so that receiving information can be continued in case that the processes fail.

The transmitter 18 receives information from the measuring sensors 16 at a predetermined information reception interval, and converts the received information into effective or averaged measuring information at a predetermined transmission interval. The transmitter 18 converts the information according to a first predetermined internal protocol. The transmitter 18 transmits information to the collector 20 with CDMA, TCP/IP or serial communication.

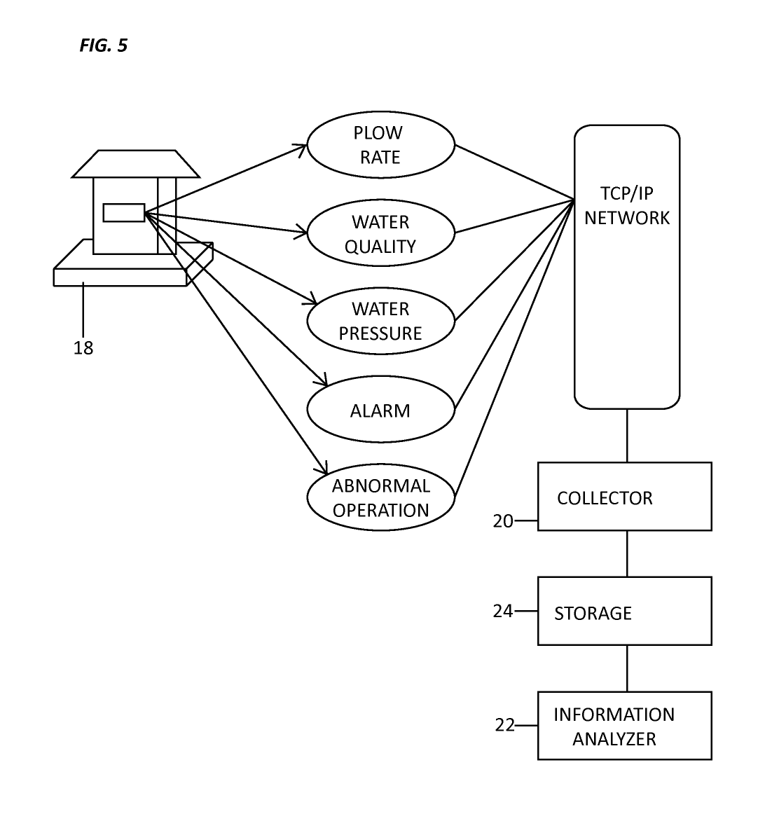

As shown in FIG. 5, the first predetermined internal protocol comprises flow rate data, water pressure data, water quality data, alarm data and control data. The flow rate data comprises flow rate measuring state, accumulated flow amount, instantaneous flow amount, flow speed and pressure. The flow rate measuring state specifies whether the measuring is normal or defective. The accumulated flow amount may either calculated by positive (+) accumulation or negative (−) accumulation. The water pressure data comprises instantaneous water pressure. The water quality data comprises UPS state (normal or defective), power supply (normal or defective), pump state (normal or defective), water pressure state (normal or defective) and measured value, pH value measuring state (normal or defective) and measured value, chlorine meter measuring state (normal or defective) and measured value, opacity meter measuring state (normal or defective) and measured value. The alarm data comprises power failure, control panel door opening and exceeding threshold values. The control data comprises data collection interval change, protocol change, fan/heater control information change and threshold value change.

The collector 20 converts the information, which are collected from the transmitter 18, according to a second predetermined internal protocol. The second predetermined internal protocol is similar to the first predetermined internal protocol but is adapted for internal data transfer between the collector 20, the storage 24 and the information analyzer 22, while the first predetermined internal protocol is adapted for handling and interpreting data packets from the sensors.

The collector 20 sends the converted information to the information analyzer 22. The collector 20 organizes the converted information per predetermined time unit. The predetermined time unit includes five (5) minutes, ten (10) minutes, one (1) hour and one (1) day.

The storage 24 stores the collected information, basic information for the pipe network 14 and all information generated by the maintenance system 10.

The maintenance system 10 further includes an alarm device 32. The status variables decided by the information analyzer 22 includes a threshold value, a leak expectation, a sensor error, and an abnormal operation. The alarm device 32 generates an alarm when the information analyzer 22 decides a leak expectation, a sensor error or an abnormal operation.

The information collected by the collector 20 includes flow rate, water pressure and water quality. The information analyzer 22 analyzes the water supply system 12 based on the flow rate, water pressure and water quality, and an initial design water pressure value of the pipe network 14. The information analyzer 22 transfers the analyzed result to the alarm device 32 and the storage 24.

The alarm generated by the alarm device 32 is classified into a plurality of levels. The alarm device 32 delivers the alarm to pre-registered users via public telecommunication network including fax, cell phones and e-mails.

The maintenance system further includes a pipe network analyzer 34 that analyzes the pipe network 14 base on the collected information.

The pipe network analyzer 34 includes an analysis storage module 36, an analysis addition module 38 and an analysis result module 40. The analysis storage module 36 manages analysis techniques. The analysis addition module 38 enables addition of analysis techniques. The analysis result module 40 provides analysis result.

The pipe network analyzer 34 analyzes the information stored by the storage 24 based on a pipe network scheme that is constructed with space data of the water supply system 12. Analysis techniques are added as plug-in modules. The analysis storage module 36 chooses an analysis technique. The pipe network analyzer 34 analyzes a metered amount ratio of the water supply system 12, and calculates water use amount and water supply amount. The information analyzed by the pipe network analyzer 34 includes flow rate, water pressure and water quality. The metered amount ratio means ratio of water amount that is paid to the total amount of water supplied. The metered amount ratio is calculated for a specific area that is being analyzed. First, boundaries for that area are identified. Second, total water amount used per water use amount metering period is investigated. Third, total water inflow (supplied) amount for that area is investigated. Based on the data obtained in this way, the metered amount ratio is calculated.

One example of an analysis technique performed by the pipe network analyzer 34 is “Gradient Method” by Todini & Pilati (1987), which provides the following equation.

Hᵢ−Hⱼ=hᵢⱼ=rQ²ᵢⱼ+mQ²ᵢⱼ

In the equation, H=Nodal Head, h=Headloss, r=Resistance Coefficient, Q=flow rate, n=flow rate coefficient, m=minor loss coefficient.

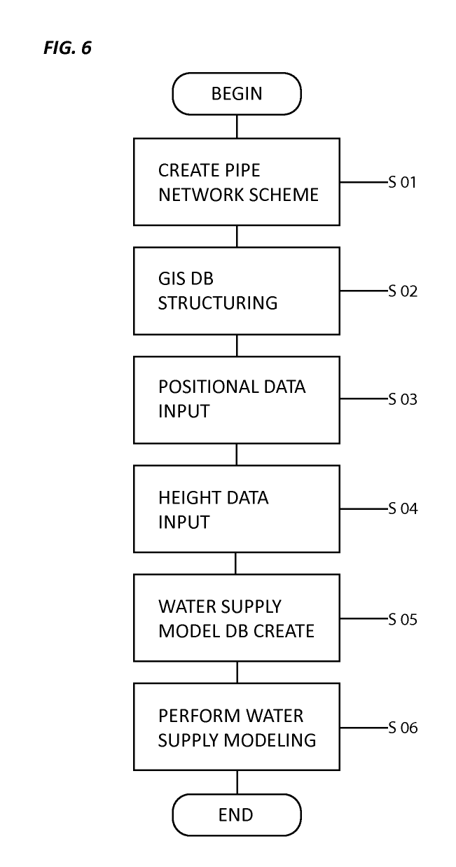

As shown in FIG. 6, the operation of the pipe network analyzer comprises step S01 of creating the pipe network scheme, step S02 of GIS database structuring, step S03 of positional data input, step S04 of height data input, step S05 of creating water supply model database and step S06 of performing water supply modeling. In step S01, water supply pipe network construction and pipe properties data are input. In step S02, database for the pipe properties are created. In step S03, ID and X-Y coordinates for the nodes are input and ID and directional information (East-West, South-North) for the pipes are created. In step S04, altitudes and contour lines are converted into GIS database, and TIN is prepared and altitude values for nodes are input. In step S05, database for nodes, pipes and demand amount are modified, and targets for pipe network analysis are prepared (pumps, reservoirs, facilities, etc.).

The maintenance system 10 further includes an information transferor 42 that includes an XML output module 44 that outputs information as XML and an XML transfer module 46 that transfers the XML output. The pipe network analyzer 34 sends the analysis result to the information transferor 42 and stores the analysis result in the storage 24.

The maintenance system 10 further includes a screen display 48. The information transferor 42 uses XML for information transfer from the storage 24 to the screen display 48. The screen display 48 displays the XML output from the information transferor 42. The screen display 48 includes a GIS processing module 50 and a screen process module 52. The screen display 48 shows the information and result via various channels including web, client/server and mobile communication environments. The screen display 48 displays information including facilities information, GIS, real time monitoring, pipe network analysis result and metered amount ratio.

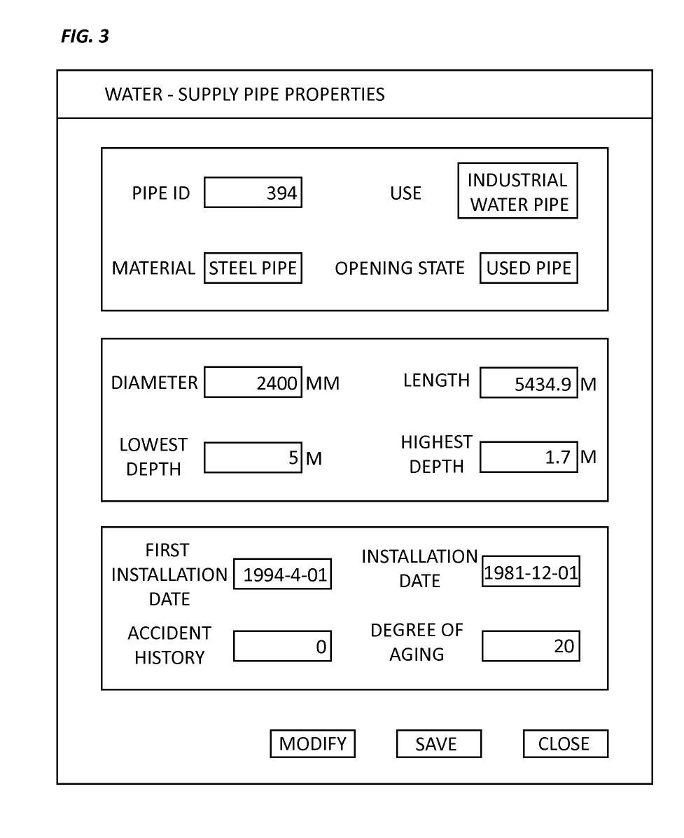

FIG. 3 shows an example of water supply pipe properties data that may be used to construct the pipe network scheme.

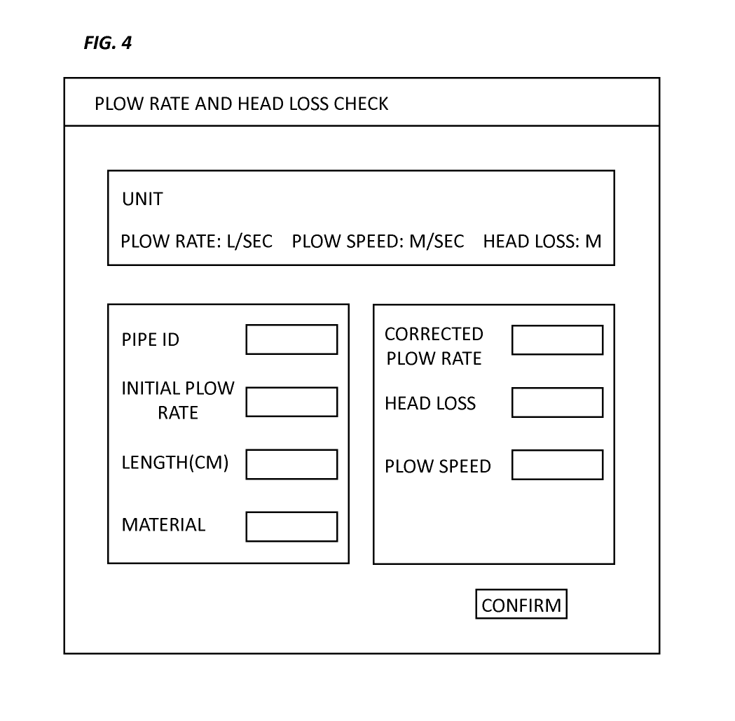

FIG. 4 shows an example of flow rate and head loss check data that may be used by the information analyzer 22 or the pipe network analyzer 34.

The maintenance system 10 provides systematic analysis results. The system monitors and analyzes water supply pipe pressure status and pipe pressure per block through real time collection of pipe pressure data. The system predicts water use amount and analyzes the minimum flow rate at night time, pipe pressure per time period, and usage pattern per hour, weekday and season. The system monitors local water pressure status in real time, provides statistical history for replacing leaking pipes and characteristics for the pipe network and flow fluctuation.

Use and application of the system may also be extended to other public facilities that cover large geographical area and a big population. Such facilities include sewage, road, electric power, gas, and communication, etc.

1. A maintenance system for a water supply system, wherein the water supply system comprises a pipe network and a plurality of measuring sensors, wherein the maintenance system comprising:
a) a transmitter that is adapted to receive information from the measuring sensors, and transmits the information;
b) a collector that collects the information transmitted by the transmitter;
c) an information analyzer that analyzes the collected information and decides prescribed status variables for the maintenance system; and
d) a storage that stores information provided by the collector and the information analyzer,
wherein the information and analysis are based on the Geographic Information System (GIS).

2. The system of claim 1, wherein the transmitter comprises an administration module that administrates processes of the transmitter, a information receiving module that receives information from the measuring sensors, and an information transmission module that transmits the received information, wherein operations of the administration module, the information receiving module and the information transmission module are independent from one another whereby receiving information can be continued in case that the processes fail.

3. The system of claim 2, wherein the transmitter receives information from the measuring sensors at a predetermined information reception interval, and converts the received information into effective measuring information at a predetermined transmission interval.

4. The system of claim 3, wherein the transmitter converts the information according to a first predetermined internal protocol.

5. The system of claim 4, wherein the first predetermined internal protocol comprises flow rate data, water pressure data, water quality data, alarm data and control data.

6. The system of claim 5, wherein the flow rate data comprises flow rate measuring state, accumulated flow amount, instantaneous flow amount, and flow speed.

7. The system of claim 6, wherein the water pressure data comprises instantaneous water pressure.

8. The system of claim 7, wherein the water quality data comprises water pressure state and measured value, pH value measuring state and measured value, chlorine meter measuring state and measured value, opacity meter measuring state and measured value.

9. The system of claim 8, wherein the alarm data comprises power failure, control panel door opening and exceeding threshold values.

10. The system of claim 9, wherein the control data comprises data collection interval change, protocol change, and threshold value change.

11. The system of claim 1, wherein the collector converts the information, which are collected from the transmitter, according to a second predetermined internal protocol.

12. The system of claim 11, wherein the collector organizes the converted information per predetermined time unit.

13. The system of claim 12, wherein the predetermined time unit comprises five (5) minutes, ten (10) minutes, one (1) hour and one (1) day.

14. The system of claim 1, wherein the storage stores the collected information, basic information for the pipe network and all information generated by the maintenance system.

15. The system of claim 1, further comprising an alarm device, wherein the status variables decided by the information analyzer comprises a threshold value, a leak expectation, a sensor error, and an abnormal operation, wherein the alarm device generates an alarm when the information analyzer decides a leak expectation, a sensor error or an abnormal operation.

16. The system of claim 15, wherein the information collected by the collector comprises flow rate, water pressure and water quality, wherein the information analyzer analyzes the water supply system based on the flow rate, water pressure and water quality, and an initial design water pressure value of the pipe network, wherein the information analyzer transfers analyzed result to the alarm device and the storage.

17. The system of claim 16, wherein the alarm generated by the alarm device is classified into a plurality of levels, wherein the alarm device delivers the alarm to pre-registered users via public telecommunication network.

18. The system of claim 1, further comprising a pipe network analyzer that analyzes the pipe network base on the collected information.

19. The system of claim 18, wherein the pipe network analyzer comprises an analysis storage module, an analysis addition module and an analysis result module, wherein the analysis storage module manages analysis techniques, wherein the analysis addition module enables addition of analysis techniques, wherein the analysis result module provides analysis result.

20. The system of claim 19, wherein the pipe network analyzer analyzes the information stored by the storage based on a pipe network scheme that is constructed with space data of the water supply system, wherein analysis techniques are added as plug-in modules, wherein the analysis storage module chooses an analysis technique.

21. The system of claim 20, wherein the pipe network analyzer analyzes a metered amount ratio of the water supply system, and calculates water use amount and water supply amount.

22. The system of claim 21, wherein the information analyzed by the pipe network analyzer comprises flow rate, water pressure and water quality.

23. The system of claim 22, wherein operation of the pipe network analyzer comprises creating the pipe network scheme, GIS database structuring, positional data input, height data input, creating water supply model database and performing water supply modeling.

24. The system of claim 23, further comprising an information transferor that comprises an XML output module that outputs information as XML and an XML transfer module that transfer the XML output.

25. The system of claim 24, further comprising a screen display, wherein the information transferor uses XML for information transfer from the storage to the screen display, wherein the screen display displays the XML output from the information transferor.

26. The system of claim 25, wherein the transmitter comprises an administration module that administrates processes of the transmitter, a information receiving module that receives information from the measuring sensors, and an information transmission module that transmits the received information, wherein operations of the administration module, the information receiving module and the information transmission module are independent from one another whereby receiving information can be continued in case that the processes fail, wherein the transmitter receives information from the measuring sensors at a predetermined information reception interval, and converts the received information into effective measuring information at a predetermined transmission interval, wherein the transmitter converts the information according to a first predetermined internal protocol, wherein the collector converts the information, which are collected from the transmitter, according to a second predetermined internal protocol, wherein the collector organizes the converted information per predetermined time unit, wherein the predetermined time unit comprises five (5) minutes, ten (10) minutes, one (1) hour and one (1) day, wherein the storage stores the collected information, basic information for the pipe network and all information generated by the maintenance system.

27. The system of claim 26, further comprising an alarm device, wherein the status variables decided by the information analyzer comprises a threshold value, a leak expectation, a sensor error, and an abnormal operation, wherein the alarm device generates an alarm when the information analyzer decides a leak expectation, a sensor error or an abnormal operation, wherein the information collected by the collector comprises flow rate, water pressure and water quality, wherein the information analyzer analyzes the water supply system based on the flow rate, water pressure and water quality, and an initial design water pressure value of the pipe network, wherein the information analyzer transfers analyzed result to the alarm device and the storage, wherein the alarm generated by the alarm device is classified into a plurality of levels, wherein the alarm device delivers the alarm to pre-registered users via public telecommunication network.
